(19) United States
(12) Patent Application Publication
(10) Pub. No.: US 2002/0014349 A1
(43) Pub. Date: Feb. 7, 2002

(54) Methods and assemblies

(76) Inventor: Guy James Ashley Dewdney, Slough (GB)

Correspondence Address: Burton A. Amernick, Connolly Bove Lodge & Hutz LLP, Suite 800, 1990 M Street, N.W., Washington, DC, 20036-3425, US

(21) Appl. No.: 09/881,841

(22) Filed: Jun. 18, 2001

(30) Foreign Application Priority Data
Jun. 16, 2000 (GB) 0014643.1

(51) Int. Cl. H02G 15/02

(52) U.S. Cl. 174/74 A

(57) ABSTRACT

A resilient insulative sleeve is carried in an expanded state extending along one end of a tubular metal carrier. The carrier has several internally-projecting crimps and a flange at one end. The carrier with the sleeve is slid onto a cable until the crimps engage an enlargement on the cable formed by connection to the cable. A tool is then used to apply force between the carrier's flange and one end of the sleeve so that the sleeve is pushed off the carrier and contracts onto the cable about the connection.

### BACKGROUND OF THE INVENTION

This invention relates to methods and assemblies The invention is more particularly concerned with methods for placing a sleeve on a cable or other elongate member.

Sleeves are often placed on cables, such as to insulate a join or connection, or for identification purposes. In one arrangement, the sleeves are of a heat-shrink material so that they can be slipped onto the cable and subsequently shrunk down to grip on the cable by applying heat, such as from a hot-air blower. This technique can work satisfactorily in some circumstances but is not suitable where the cable or surrounding items could be damaged by the heat. Also, it can be difficult to ensure that the sleeve remains in the desired position while the heat is applied. Alternatively, the sleeve can be made of a resilient material with a natural internal diameter less than the external diameter of the cable or other member on which it is to be mounted. The sleeve is then mechanically expanded with a suitable tool sufficiently to be slipped over the cable to the desired position at which the tool releases the sleeve to allow it to contract about the cable. The tool may take the form of a pliers device with three prongs onto which the sleeve is slid, the prongs then being moved away from one another by squeezing together the handles of the tool. This tool, however, is not suitable with sleeves of small diameter because the prongs of the tool would need to be very thin. Alternatively, the tool may take the form of a rod-like jig, which tapers along its length and which has a groove along one side. The user slips the sleeve onto the jig and pushes it along its length to expand to a larger diameter than the cable. The user then pushes one end of the cable into the groove so that it projects through the sleeve. The sleeve is then pushed off the jig onto the cable. The problem with this jig is that the action of pushing the sleeve off the jig can displace the sleeve from the desired position on the cable. Whilst this may not be very important for marker sleeves, it is a problem when the sleeves need to be accurately positioned, such as at connections or joins.

### BRIEF SUMMARY OF THE INVENTION

It is an object of the present invention to provide an alternative method for placing a sleeve on an elongate member.

According to one aspect of the present invention there is provided a method of placing a resilient sleeve on an elongate member, comprising the steps of providing the sleeve in an expanded state on a hollow carrier element with the sleeve extending along a part of the length of the carrier element, threading the carrier element with the sleeve onto the elongate member, displacing the sleeve off the carrier element so that the sleeve contracts onto the elongate member and removing the carrier element from the elongate member.

The method may include a preliminary step of expanding and loading the sleeve onto the carrier element. The sleeve and carrier element are preferably slid apart using a tool arranged to apply a force between an exposed part of the carrier element and an end of the sleeve. The carrier element with the sleeve may be threaded onto the elongate member until a surface formation on the inside of the carrier element engages a surface formation on the elongate member. The sleeve and carrier element are preferably slid apart without any substantial movement of the sleeve along the elongate member. The elongate member may be a cable.

According to a second aspect of the present invention there is provided a method of placing a resilient, insulative sleeve on a cable, comprising the steps of providing the sleeve in an expanded state on a hollow carrier element with the sleeve extending along a part of the length of the carrier element, the carrier element having an internal projection, threading the carrier element with the sleeve on the cable until the internal projection on the sleeve abuts an enlargement on the cable, displacing the sleeve off the carrier element so that it contracts onto the cable and removing the carrier element from the cable.

The enlargement on the cable may be where connection is made to a screen of the cable, the sleeve being displaced off the carrier element about the connection to the screen.

According to a third aspect of the present invention there is provided a sub-assembly of a carrier element and a sleeve on the carrier element for use in a method according to the above one or second aspect of the invention.

The carrier element preferably has a surface formation on its inner surface for location on the elongate member. The carrier element is preferably a tube of metal such as tin-plated copper and the surface formation on the inner surface of the carrier element is preferably formed by crimping. The carrier element preferably has an external flange at one end remote from the sleeve. The sleeve may be of silicone rubber.

According to a fourth aspect of the present invention there is provided an assembly of an elongate member and a sub-assembly according to the above third aspect of the invention.

According to a fifth aspect of the present invention there is provided an assembly of an elongate member and a sub-assembly threaded on the elongate member, the sub-assembly comprising a hollow carrier element carrying a resilient sleeve in an expanded state on the carrier element, such that the sleeve can be displaced off the carrier element onto the elongate member.

The elongate member is preferably an electrical cable.

A method of placing a sleeve on a cable, according to the present invention, will now be described, by way of example, with reference to the accompanying drawings.

### BRIEF DESCRIPTION OF THE DRAWINGS

FIG. 1 is a side elevation view of a sub-assembly of a carrier and sleeve;

FIG. 2 is a transverse section of the sub-assembly along the line II-II of FIG. 1;

FIG. 3 is a side elevation view illustrating assembly of the sleeve on the carrier;

FIGS. 4 to 6 illustrate steps in the method;

FIG. 7 is an end view of an alternative carrier in a closed state; and

FIG. 8 is a perspective view of the carrier of FIG. 7 in an open state.

### DETAILED DESCRIPTION OF THE PREFERRED EMBODIMENTS

The method involves use of a sub-assembly 1 of a sleeve 2 on a carrier 3, which is threaded onto the cable 5, the sleeve being slid off the carrier so that it contracts about the cable, after which the carrier is removed.

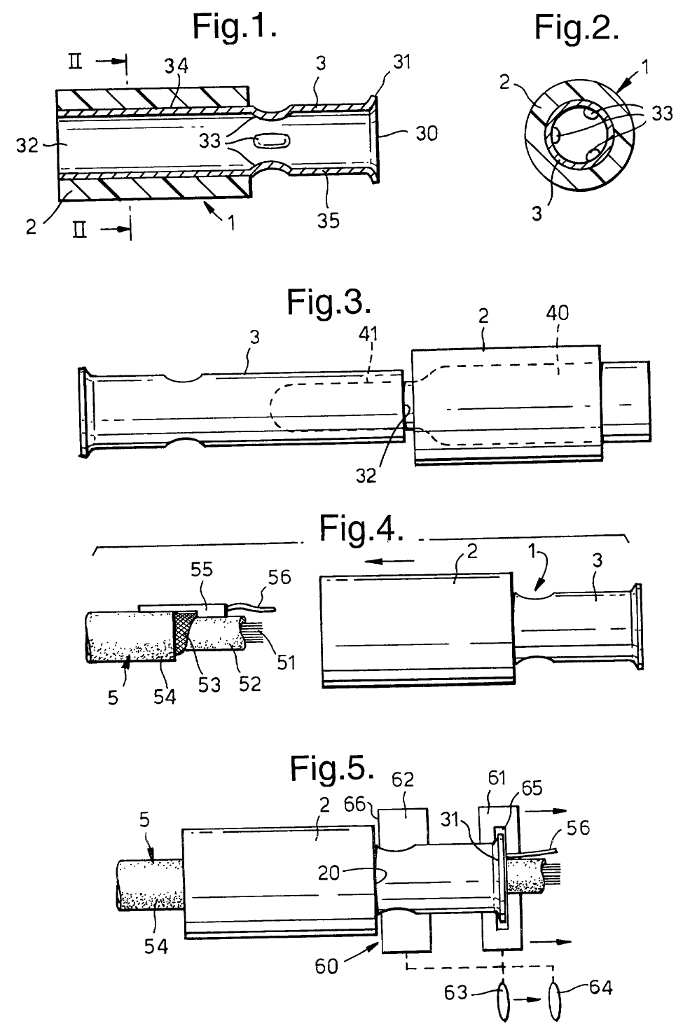

With reference first to FIGS. 1 and 2, the carrier 3 is a thin-walled tube of tin-plated copper. The carrier 3 has a circular section and is about 17 mm long and with an external diameter of 3.3 mm. At its right-hand end 30, the carrier 3 has a small, radially-projecting flange 31, the other end 32 of the carrier being plain. The wall of the carrier 3 is crimped inwardly to form three surface formations in the form of projections 33 on the inside of the carrier spaced around its circumference. The projections 33 are spaced slightly closer to the flanged end 30 of the carrier leaving a smooth region 34 about 10 mm long extending from the plain end 32. These carriers 3 can be provided at very low cost.

The sleeve 2 is of a resilient, insulative material, such as silicone rubber. The sleeve 2 is about 10 mm long and, in its natural, unexpanded state, has an internal diameter of 1.5 mm. The sleeve 2 is expanded when loaded on the carrier 3 and extends from the plain end 32 along the smooth region 34. This leaves exposed the right-hand portion 35 of the carrier 3, between the internal projections 33 and the flange 31.

The sleeve 2 may be loaded on the carrier 3 in many different ways. One possible way is illustrated in FIG. 3. In this, the sleeve 2 is slid onto a tapered mandrel 40 from its narrow, left-hand end 41 so that it is expanded radially to a diameter slightly greater than the external diameter of the carrier 3. The plain end 32 of the carrier 3 is then pushed along the narrow end 41 of the mandrel 40 so that the sleeve 2 can be slid off the mandrel onto the carrier. This or other loading methods can readily be carried out by automated machine.

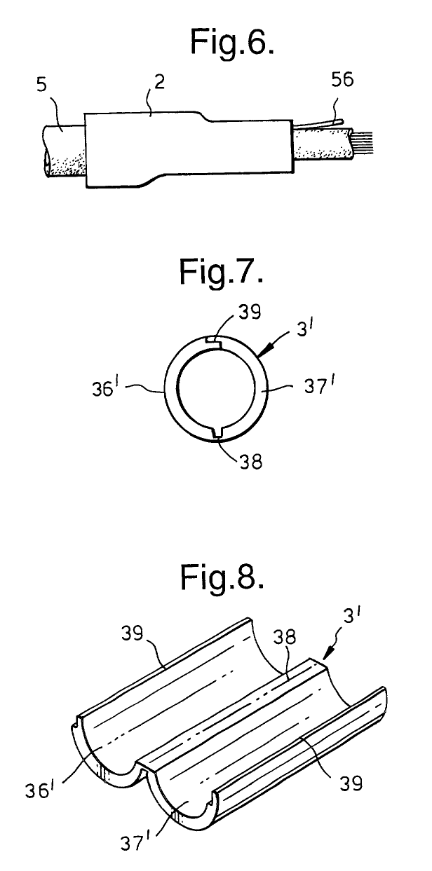

The sub-assemblies 1 are produced in the factory and supplied to the end user who assembles the sleeve onto the cable 5, as shown in FIGS. 4 to 6.

The cable 5 comprises an inner conductor 51 within an insulating sleeve 52, which is in turn surrounded by a braided screening sleeve 53 and an outer insulating jacket 54. The jacket 54 is stripped off the forward end of the cable 5 exposing the screen 53, which is crimped into a metal connection 55 together with the end of a grounding wire 56. This form of cable assembly is described in more detail in GB 2343063.

The user takes a sub-assembly 1 and threads it onto the forward end of the cable 5 such that the end of the carrier 3 supporting the sleeve 2 faces the direction in which the subassembly is threaded. The internal diameter of the carrier 3 in its largest part, where it is not restricted by the projections 33, is such that it can be slid over the largest part of the cable 5 in the region where the metal connection 55 overlaps the insulating jacket 54. The narrowest part of the carrier 3, however, in the region of the projections 33, will receive the conductor 51 within its insulating sleeve 52 and the grounding wire 56 but is too narrow to pass beyond the forward end of the metal connection 55. The user, therefore, slides the sub-assembly 1 as far as possible along the cable 5 until its projections 33 abut the enlargement of the cable produced by the screen 53, jacket 54 and connection 55. In this position, the forward, left-hand end of the sub-assembly 1 overlaps the metal connection 55, the exposed part of the screen 53 and a part of the jacket 54, as shown in FIG. 5. The user then takes a hand tool 60 (only shown schematically in FIG. 5) and uses this to displace the sleeve 2 off the left-hand end 32 of the carrier 3. More particularly, as shown in FIG. 7, the tool 60 has two jaws 61 and 62 connected to respective handles 63 and 64. One jaw 61 has a groove 65 shaped to receive the flange 31 on the carrier 3, whereas the other jaw 62 has an end surface 66 shaped to engage the face 20 at the end of the sleeve 2. When the tool 60 is gripped, the handle 63 coupled with the jaw 61 is moved towards the other handle 64, which remains relatively stationary. In this way, the carrier 3 is moved rearwardly whereas the sleeve 2 remains in the same position along the cable 5. Because the jaw 62 of the tool pushes against a face 20 of the sleeve 2 rather than gripping its outer surface, it does not increase the friction between the sleeve and the carrier.

As the sleeve 2 slides off the left-hand end of the carrier 3, it immediately starts to contract about the cable 5 back towards its natural diameter, which is smaller than the diameter of the cable. The sleeve 2 may take some time to apply its maximum contractive force to the cable, depending on storage time and conditions of the sub-assembly 1, but the initial force is sufficient to retain the sleeve securely in position on the cable. The length and position of the sleeve 2 is such that it covers the metal connection 55 and that part of the screening sleeve 53 projecting from the jacket 54. The tool 60 retains the carrier 3 for suitable disposal or recycling.

The carrier could take various different forms and need not be a metal tube of the kind described above. With reference to FIGS. 7 and 8, the carrier 3′ could be moulded of a rigid plastics material to have two semi-cylindrical portions 36′ and 37′ connected along one edge 38′ by an integral resilient living hinge and having cooperating tongue and groove formations along their free edges 39′. When closed, as shown in FIG. 8, the edges 39′ engage to form a rigid tube onto which the sleeve can be loaded. When the sleeve is removed, the two portions 36′ and 37′ spring apart about the hinged edge 38′, as shown in FIG. 8. This form of carrier could be easier to use where the sleeve is to be placed a long way from a free end of the cable, since it avoids the need to unthread the used carrier from the free end of the cable.

The present invention can be used with sleeves of any size and can be used with any elongate members, not just cables. The invention could be used, for example, to join two tubes by applying a sleeve extending over contacting ends of the tubes. The invention could be used to apply marker sleeves or to apply sleeves to cover damage to a cable.

The invention enables accurate placement of sleeves of various sizes and without the need to use heat.

What I claim is:

1. A method of placing a resilient sleeve on an elongate member, comprising the steps of: providing said sleeve in an expanded state on a hollow carrier element with said sleeve extending along a part of the length of said carrier element; threading said carrier element with said sleeve onto said elongate member; displacing said sleeve off said carrier element so that said sleeve contracts onto said elongate member and removing said carrier element from said elongate member.

2. A method according to claim 1 including a preliminary step of expanding and loading said sleeve onto said carrier element.

3. A method according to claim 1, wherein said sleeve and said carrier element are slid apart using a tool arranged to apply a force between an exposed part of said carrier element and an end of said sleeve.

4. A method according to claim 1, wherein said carrier element has a surface formation on its inside and said elongate member has a surface formation on its outside, and wherein said carrier element with said sleeve is threaded onto said elongate member until said surface formation on said carrier element engages said surface formation on said elongate member.

5. A method according to claim 1, wherein said sleeve and said carrier element are slid apart without any substantial movement of said sleeve along said elongate member.

6. A method according to claim 1, wherein said elongate member is a cable.

7. A method of placing a resilient, insulative sleeve on a cable, comprising the steps of:
providing said sleeve in an expanded state on a hollow carrier element with said sleeve extending along a part of the length of said carrier element, and said carrier element having an internal projection; threading said carrier element with said sleeve on said cable until said internal projection on said sleeve abuts an enlargement on said cable; displacing said sleeve off said carrier element so that said sleeve contracts onto said cable; and removing said carrier element from said cable.

8. A method according to claim 7, wherein said enlargement on said cable is provided by a connection made to a screen of said cable, and wherein said sleeve is displaced off said carrier element about said connection to said screen.

9. A sub-assembly comprising: a hollow carrier element and a sleeve of a resilient material expanded onto said carrier element and extending along a part of the length of said carrier element such that said sleeve can be displaced off said carrier element when said carrier element is threaded onto an elongate member so that said sleeve contracts onto said elongate member.

10. A sub-assembly according to claim 9, wherein said carrier element has a surface formation on its inner surface for location on said elongate member.

11. A sub-assembly according to claim 9, wherein said carrier element is a tube of metal.

12. A sub-assembly according to claim 11, wherein said carrier element is of tin-plated copper.

13. A sub-assembly according to claim 11, wherein said carrier element has a surface formation on its inner surface for location on said elongate member, and wherein said surface formation is formed by crimping.

14. A sub-assembly according to claim 9, wherein said carrier element has an external flange at one end remote from said sleeve.

15. A sub-assembly according to claim 9, wherein said sleeve is of silicone rubber.

16. An assembly comprising: an elongate member and a sub-assembly threaded on said elongate member, wherein said sub-assembly comprises a hollow carrier element and a resilient sleeve carried on said carrier in an expanded state such that said sleeve can be displaced off said carrier element to contract onto said elongate member.

17. An assembly according to claim 16, wherein said elongate member is an electrical cable.
